(19) United States
(12) Patent Application Publication
(10) Pub. No.: US 2005/0137375 A1
(43) Pub. Date: Jun. 23, 2005

(54) Polyurethane-based pressure sensitive adhesives and methods of manufacture

(75) Inventors: Richard G. Hansen, Mahtomedi, MN (US); Zhiming Zhou, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/742,420

(22) Filed: Dec. 19, 2003

(51) Int. Cl. C08G 18/00

(52) U.S. Cl. 528/44

(57) ABSTRACT

Polyurethane-based pressure sensitive adhesives comprising the reaction product of: an isocyanate-reactive component comprising at least two isocyanate-reactive materials, an isocyanate-functional component; a reactive emulsifying compound; a chain capping agent and an optional chain extending agent. The adhesives, which are preferably pressure sensitive adhesives, can be prepared from 100% solids, waterborne or solventborne systems.

### BACKGROUND OF THE INVENTION

A wide variety of polyurethane-based adhesives are known. The adhesives may be prepared from 100% solids (i.e., essentially solvent-free and water-free) systems, solventborne (i.e., those using mostly organic solvents as a solvating medium) systems or waterborne (i.e., those using mostly water as a dispersing medium) systems.

The 100% solids systems are generally hot melt or reactive systems. In hot melt systems, a polyurethane-based polymer is heated to a temperature at or above its melting point, delivered to a substrate in the molten state, and a bond is formed before the polymer is able to cool to its pre-heated state. In reactive systems, typically multiple parts must be mixed to form a coatable reacting mixture. The reacting mixture must then be coated onto a substrate within a short period of time. If the reacting mixture is not coated within a short period of time, the viscosity of the composition will become too high, rendering the composition uncoatable.

In addition, the parts of a reactive polyurethane-based adhesive system include an isocyanate-containing part (i.e., an isocyanate-terminated polyurethane prepolymer) and a chain extending part. Due to the presence of isocyanate-functional groups on the polyurethane prepolymer, storage of that part must be carefully controlled so that moisture does not react with the isocyanate-functional groups, rendering the composition non-reactive and, thus, unusable. Sensitivity to moisture can also lead to variations in properties of these coated adhesives due to, for example, local variations in ambient temperature and humidity when the adhesive is coated. Furthermore, special handling procedures may be required for the multi-part system, especially by those that are sensitive to isocyanate chemicals.

In contrast, when using a non-reactive solventborne or waterborne systems to form an adhesive coating on a substrate, one merely applies the composition, which contains a fully reacted polymer in the form of a solution or dispersion, to the substrate and then dries the solvating or dispersing medium to form the adhesive coating. However, such non-reactive systems may require the addition of external emulsifiers or internal stabilization agents to maintain stability of the solution or dispersion prior to coating to form the adhesive.

Most of the polyurethane-based adhesive systems that have been developed are not pressure sensitive adhesives (PSAs). PSA compositions are a unique subset of adhesives well known to those of ordinary skill in the art to possess properties including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs are polymers designed and formulated to exhibit the requisite viscoelastic properties resulting in a desired balance of tack, peel adhesion, and shear holding power. As noted in U.S. Pat. No. 5,591,820, “the difficulty of attaining this balance of viscoelastic characteristics in a polyurethane explains the paucity of prior art polyurethane PSA literature.”

Hot melt polyurethane-based adhesives are generally not PSAs as they only have tack in the molten state. Many reactive systems are not PSAs as the adhesive formed goes through a temporary tacky state without permanent and aggressive tack. Likewise, many solventborne and waterborne adhesive systems are also not PSAs.

### SUMMARY OF THE INVENTION

Polyurethane-based pressure sensitive adhesives (PSAs) of the invention comprise the reaction product of an isocyanate-reactive component comprising at least two isocyanate-reactive materials, the at least two isocyanate-reactive materials comprising a first isocyanate-reactive material comprising at least one diol having a weight average molecular weight of at least about 2,000, wherein the at least one diol comprises less than about 8 weight % monols, and a second isocyanate-reactive material comprising at least one polyol with more than two hydroxy-functional groups; an isocyanate-functional component; a reactive emulsifying compound; a chain capping agent; and an optional chain extending agent, wherein the adhesive is prepared from a waterborne system.

In one embodiment, the polyol component comprises at least one polyoxyalkylene polyol. In another embodiment, at least one polyol in the isocyanate-reactive component is a diol. In another embodiment, the at least one diol comprises a diol having a ratio of diol molecular weight to weight % monol of at least about 800.

According to one aspect, the second isocyanate-reactive material comprises up to 50% of the isocyanate-reactive component based on total weight of the isocyanate-reactive component. For example, in one embodiment, the second isocyanate-reactive material comprises about 1 to about 50 percent by weight of the isocyanate-reactive component. In yet another embodiment, the second isocyanate-reactive material comprises about 5 to about 30 percent by weight of the second isocyanate-reactive component.

In one embodiment, the isocyanate-functional component comprises a diisocyanate. In one embodiment, the reactive emulsifying compound comprises at least about 0.5% by weight of the total reactants. In one embodiment, the pressure sensitive adhesive composition further comprises an antimicrobial agent.

In another aspect a method of preparing a polyurethane-based pressure-sensitive adhesive is provided, comprising providing an isocyanate-reactive component comprising at least two isocyanate-reactive materials, the at least two isocyanate-reactive materials comprising a first isocyanate-reactive material comprising at least one diol having a weight average molecular weight of at least about 2,000, wherein the at least one diol comprises less than about 8 weight % monols, and a second isocyanate-reactive material comprising at least one polyol with more than two hydroxyl-functional groups; providing an isocyanate-functional component; providing a reactive emulsifying compound; allowing the isocyanate-reactive component, the isocyanate-functional component, and the reactive emulsifying compound to react to form an isocyanate-functional polyurethane prepolymer; adding a chain capping agent; and chain extending the polyurethane prepolymer.

In another aspect, the chain capping agent is added in an amount effective to cap up to 50% of the isocyanate-functional groups of the prepolymer. In some embodiments, chain capping agent is added in an amount effective to cap between 5 and 40% of the isocyanate-functional groups of the prepolymer. Typically, the isocyanate-functional prepolymer contains on average less than 2.5 isocynate-functional groups. In another aspect, the chain capping agent is added before isocyanate-functional polyurethane prepolymer is formed.

In another aspect, the polyurethane-based pressure sensitive adhesive, comprising the reaction product of an isocyanate-reactive component comprising at least two isocyanate-reactive materials, the at least two isocyanate-reactive materials comprising a first isocyanate-reactive material comprising at least one difunctional compound with two active hydrogens having a weight average molecular weight of at least about 2,000, wherein the at least one difunctional compound comprises less than about 8 weight % monofunctional compounds, and a second isocyanate-reactive material comprising at least one multifunctional compound with at least three active hydrogens; an isocyanate-functional component; a reactive emulsifying compound; a chain capping agent; and an optional chain extending agent wherein the adhesive is prepared from a waterborne system.

PSAs of the invention may be at least partially coated on a substrate. For example, PSAs of the invention are useful in tapes. The tapes comprise a backing having a first and second side and the PSA coated on at least a portion of the first side of the backing and, optionally, on at least a portion of the second side of the backing.

According to further embodiments, the method can further comprise the step of dispersing the polyurethane prepolymer in a dispersing medium. In still further embodiments, the method can further comprise coating and drying the dispersing medium to form a coating of the polyurethane-based PSA.

### DETAILED DESCRIPTION OF THE PREFERRED EMBODIMENTS

Pressure sensitive adhesives (PSAs) of the invention are polyurethane-based. The term “polyurethane” as used herein includes polymers containing urethane (also known as carbamate) linkages, urea linkages, or combinations thereof, i.e., in the case of poly(urethane-urea)s. Thus, polyurethane-based PSAs of the invention contain at least urethane linkages and, optionally, urea linkages. Furthermore, PSAs of the invention are based on polymers where the backbone has at least 80% urethane and/or urea repeat linkages formed during the polymerization process, such as the polymerization processes described below. That is, the polyurethane-based polymers are formed from prepolymers that are preferably terminated by isocyanate groups. Further reactants used to form the PSAs from the prepolymers are selected such that no more than about 20%, preferably no more than about 10%, more preferably no more than about 5%, and preferably none of the repeat linkages between polymeric segments formed in the polymeric backbone during polymerization are other than urethane and urea linkages.

PSAs of the invention are typically prepared from systems that are essentially non-reactive. In most embodiments, polyurethane-based PSA systems of the invention are storage-stable. “Storage-stable” PSA systems are those compositions that can be coated on a substrate to form a continuous film at any time after the composition is formed up until the shelf life of the material has expired. Preferably, the shelf life of the material is at least three days, more preferably at least about one month, even more preferably at least about six months, and most preferably at least about one year.

PSAs of the present invention may be derived from 100% solids, solventborne or waterborne systems. Waterborne systems are desirable for cost, environmental, safety, and regulatory reasons. Thus, in most embodiments, the polyurethane-based PSAs of the invention are derived from waterborne systems, using water as the primary dispersing medium.

Dispersions of the invention are prepared by reacting components, including at least two isocyanate-reactive (e.g., hydroxy-functional, such as polyol) components, at least one isocyanate-functional (e.g., polyisocyanate) component, and at least one reactive emulsifying compound, to form an isocyanate-terminated polyurethane prepolymer. The two isocyanate-reactive components have different functionality, i.e., have differing amounts of isocyanate-reactive groups, which are used in conjunction with a monofunctional capping agent. The polyurethane prepolymer is then dispersed, and chain-extended, in a dispersing medium such as water to form polyurethane-based dispersions of the invention.

PSAs formed from the polyurethane-based polymers of the invention are inherently tacky and demonstrate PSA characteristics without the addition of plasticizers or tackifiers. A balance of permanent tack and cohesive strength is achieved by controlling the polymer architecture with the selection, purity, and ratio of components.

While the present invention contemplates the use of aromatic compounds, the PSAs of the present invention typically include less than 5% aromatic content.

Components of polyurethane-based PSAs of the invention are further described below, with reference to certain terms understood by those in the chemical arts as referring to certain hydrocarbon groups. Reference is also made throughout the specification to polymeric versions thereof. In that case, the prefix “poly” is inserted in front of the name of the corresponding hydrocarbon group.

Except where otherwise noted, such hydrocarbon groups, as used herein, may include one or more heteroatoms (e.g., oxygen, nitrogen, sulfur, or halogen atoms), as well as functional groups (e.g., oxime, ester, carbonate, amide, ether, urethane, urea, carbonyl groups, or mixtures thereof).

The term “aliphatic group” means a saturated or unsaturated, linear, branched, or cyclic hydrocarbon group. This term is used to encompass alkylene (e.g., oxyalkylene), aralkylene, and cycloalkylene groups, for example.

The term “alkylene group” means a saturated, linear or branched, divalent hydrocarbon group. Particularly preferred alkylene groups are oxyalkylene groups.

The term “oxyalkylene group” means a saturated, linear or branched, divalent hydrocarbon group with a terminal oxygen atom.

The term “aralkylene group” means a saturated, linear or branched, divalent hydrocarbon group containing at least one aromatic group.

The term “cycloalkylene group” means a saturated, linear or branched, divalent hydrocarbon group containing at least one cyclic group.

The term “oxycycloalkylene group” means a saturated, linear or branched, divalent hydrocarbon group containing at least one cyclic group and a terminal oxygen atom.

The term “aromatic group” means a mononuclear aromatic hydrocarbon group or polynuclear aromatic hydrocarbon group. The term includes arylene groups.

The term “arylene group” means a divalent aromatic group.

The term “capping agent” means a monofunctional compound whose functionality is capable of reacting with an isocyanate group.

Isocyanate-Reactive Components

Any suitable isocyanate-reactive component can be used in the present invention. The isocyanate-reactive component contains at least two isocyanate-reactive materials. As understood by one of ordinary skill in the art, an isocyanate-reactive material includes at least one active hydrogen. Those of ordinary skill in the polyurethane chemistry art will understand that a wide variety of materials are suitable for this component. For example, amines, thiols, and polyols are isocyanate-reactive materials.

Multifunctional isocyanate-reactive materials, as opposed to monofunctional isocyanate-reactive materials, have at least two active hydrogens. Generally difunctional, i.e. two active hydrogens, and trifunctional, i.e., three active hydrogens, isocyanate-reactive materials are used in the present invention. If highly pure, i.e., functionality of approximately 2.0, difunctional isocyanate-reactive materials are desirable because they contribute to formation of relatively high molecular weight polymers. PSAs prepared from such multifunctional isocyanate-reactive materials generally have increased shear strength, peel adhesion, and/or a balance thereof, to provide PSA properties that may be desired for certain applications. When trifunctional isocyanate-reactive materials are used, they are generally used in conjunction with capping agents. It is preferred that the polyol component be “highly pure” (i.e., the polyol approaches its theoretical functionality—e.g., 2.0 for difunctional, 3.0 for trifunctional, etc.).

The use of trifunctional isocyanate-reactive materials in conjunction with capping agents, i.e., through the difunctional/trifunctional ratio and the amount of capping agent, provide additional means of controlling the PSA properties by controlling the molecular weight of the polymer, and the number of terminated chain ends or pendant groups. In contrast, polymers having a relatively large amount of crosslinking (i.e., without capping agents) generally are not suitable for many PSA applications and/or materials therefrom may not be readily processable.

In certain embodiments, at least one of the isocyanate-reactive materials is a hydroxy-functional material. Polyols are the preferred hydroxy-functional material used in the present invention. Polyols of the invention can be of any molecular weight, including relatively low molecular weight polyols (i.e., having a weight average molecular weight of less than about 250) commonly referred to as “chain extenders” or “chain extending agents,” as well as those polyols having higher molecular weights. Polyols provide urethane linkages when reacted with an isocyanate-functional component, such as a polyisocyanate.

Polyols, as opposed to monols, have at least two hydroxy-functional groups. Generally diols and triols are used in the present invention. Diols of high purity as discussed below are desirable because they contribute to formation of relatively high molecular weight polymers. PSAs prepared from such diols generally have increased shear strength, peel adhesion, and/or a balance thereof, to provide PSA properties that may be desired for certain applications.

When triols are used, they are generally used in conjunction with capping agents. The use of triols in conjunction with capping agents, i.e., through the diol/triol ratio and the amount of capping agent, provide additional means of controlling the PSA properties by controlling the molecular weight of the polymer, and the number of terminated chain ends or pendant groups. In contrast, polymers having a relatively large amount of crosslinking (i.e., without capping agents) generally are not suitable for many PSA applications and/or materials therefrom may not be readily processable.

Examples of polyols useful in the present invention include, but are not limited to, polyester polyols (e.g., lactone polyols) and the alkylene oxide (e.g., ethylene oxide; 1,2-epoxypropane; 1,2-epoxybutane; 2,3-epoxybutane; isobutylene oxide; and epichlorohydrin) adducts thereof, polyether polyols (e.g., polyoxyalkylene polyols, such as polypropylene oxide polyols, polyethylene oxide polyols, polypropylene oxide polyethylene oxide copolymer polyols, and polyoxytetramethylene polyols; polyoxycycloalkylene polyols; polythioethers; and alkylene oxide adducts thereof), polyalkylene polyols, mixtures thereof, and copolymers therefrom. Polyoxyalkylene polyols are preferred.

When copolymers of polyols are used, chemically similar repeating units may be randomly distributed throughout the copolymer or in the form of blocks in the copolymer. Similarly, chemically similar repeating units may be arranged in any suitable order within the copolymer. For example, oxyalkylene repeating units may be internal or terminal units within a copolymer. The oxyalkylene repeating units may be randomly distributed or in the form of blocks within a copolymer. One preferred example of a copolymer containing oxyalkylene repeating units is a polyoxyalkylene-capped polyoxyalkylene polyol (e.g., a polyoxyethylene-capped polyoxypropylene).

Certain applications will benefit from using PSAs having fewer residuals (i.e., reactive components, such as monomers, that remain unreacted in the reaction product) than conventional PSAs. Such applications include, for example, electronics applications and medical applications. For example, the presence of residuals in PSAs used for electronics applications may contaminate other components in the electronic component, for example, by acting as a plasticizer. Plasticization of magnetic media in a hard disk drive could result in a shortened useful life for the hard disk drive. The presence of residuals in PSAs used for medical applications may cause irritation, sensitization, or skin trauma if the residuals migrate from the PSA to the surface in contact with skin, for example, as described by Kydonieus et al., in U.S. Pat. No. 5,910,536, as being associated with acrylate-based adhesives.

When higher molecular weight polyols (i.e., polyols having weight average molecular weights of at least about 2,000) are used, it is preferred that the polyol component be “highly pure” (i.e., the polyol approaches its theoretical functionality—e.g., 2.0 for diols, 3.0 for triols, etc.), as described in U.S. Pat. No. 6,642,304 (Hansen et. al) and U.S. Pat. No. 6,518,359 (Clemens et al), which are incorporated herein by reference. These highly pure polyols preferably have a ratio of polyol molecular weight to weight % monol of at least about 800, preferably at least about 1,000, and more preferably at least about 1,500. For example, a 12,000 molecular weight polyol with 8 weight % monol has such a ratio of 1,500 (i.e., 12,000/8=1,500). Preferably, the highly pure polyol contains about 8% by weight monol or less.

Generally, as the molecular weight of the polyol increases, a higher proportion of monol may be present in the polyol. For example, polyols having molecular weights of about 3,000 or less preferably contain less than about 1% by weight of monols. Polyols having molecular weights of greater than about 3,000 to about 4,000 preferably contain less than about 3% by weight of monols. Polyols having molecular weights of greater than about 4,000 to about 8,000 preferably contain less than about 6% by weight of monols. Polyols having molecular weights of greater than about 8,000 to about 12,000 preferably contain less than about 8% by weight of monols. Examples of highly pure polyols include those available from Bayer Corp. of Houston, Tex., under the trade designation, ACCLAIM.

Other benefits derived from using highly pure polyols include the ability to form relatively high molecular weight polymers without undesirable levels of crosslinking. For example, when conventional diols (e.g., those diols having greater than about 10% by weight or greater of monols) are used to prepare polyurethanes, higher functional polyols (e.g., triols) are also typically used in an attempt to balance the stoichiometric ratio of isocyanate-reactive (e.g., hydroxy-functional) groups to isocyanate-functional groups in the reaction mixture. It is the higher-functional polyols (i.e., those having more than two hydroxy-functional groups) that predominantly contribute to crosslinking of the polymer.

In general, preferred polyols useful in the present invention can be represented by Formulas I and II:
HO—W—OH I
W(OH)ₙ II
Wherein n equals 3 or more, W represents an aliphatic group, aromatic group, mixtures thereof, polymers thereof, or copolymers thereof. In Formula II, W is n-valent. Preferably W is a polyalkylene group, polyoxyalkylene group, or mixtures thereof.

When higher functional polyols are used, the amount of crosslinking is controlled by the use of a capping agent. These higher functional polyols comprise one of the at least two isocyanate-reactive components, and are used in combination with other isocyanate-reactive materials for the isocyanate-reactive component. The triols are used in conjunction with a capping agent to avoid significant crosslinking of the polymer while providing an optimal balance of pressure sensitive adhesive properties through controlled ratios of the triol to other components.

In general, the greater the amount of triol in the isocyanate-reactive component; the greater the cohesive strength of the polymer with a corresponding decrease in tackiness. In most embodiments, the triol can be present in amounts up to 50% in the isocyanate-reactive component. The diol to triol ratio will typically range between 99:1 to 50:50. In preferred embodiments, the diol to triol ratio will range between 95:5 to 70:30. Thus, this aspect of the present invention provides PSAs that can be used in applications where higher holding power is desired, but ease of removability from the adherend is also desired. However, the ratio and types of materials in the isocyanate-reactive component mixture can be adjusted to obtain a wide range of shear strengths and peel adhesions in PSAs prepared therefrom.

In addition to their use as one of the isocyanate-reactive materials in the isocyanate-reactive component, the higher functional polyols can also be used as a source of diols for use in the isocyanate-reactive component. After conversion, the reaction products of the higher functional polyols are considered diols according to the present invention. For example, one preferred class of higher functional polyols that can be used as an isocyanate-reactive material and as a source of diols in the present invention includes polyoxyalkylene triols, which can be reacted with a carboxylic acid cyclic anhydride or a sulfocarboxylic acid cyclic anhydride to reduce the functionality thereof. The polyoxyalkylene triol is preferably polyoxypropylene or, more preferably, a polyoxypropylene polyoxyethylene copolymer. The cyclic carboxylic anhydride is preferably selected from anhydrides such as succinic; glutaric; cyclohexanedicarboxylic; methylsuccinic; hexahydro-4-methylphthalic; phthalic; 1,2,4-benzenetricarboxylic; maleic; fumaric; itaconic; 3,4,5,6-tetrahydrophthalic; 1-dodecen-1-yl succinic; cis-aconitic; and mixtures thereof. The sulfocarboxylic cyclic anhydride is preferably 2-sulfobenzoic acid cyclic anhydride.

When the triol is used to prepare the diol, the ester-acid reaction products contribute to the emulsifying effect in addition to the reactive emulsifying compound, which is described below, when preparing polyurethane-based dispersions of the invention.

For broader formulation latitude, more than two isocyanate-reactive materials, such as polyols, may be used for the isocyanate-reactive component. For example, a mixture of diols of differing molecular weights can be used as one of the at least two isocyanate-reactive materials, as described in U.S. Pat. No. 6,642,304 (Hansen et al).

Isocyanate-Functional Component

The isocyanate-reactive component is reacted with an isocyanate-functional component during formation of the polyurethane-based PSAs of the invention. The isocyanate-functional component may contain one isocyanate-functional material or mixtures thereof. Polyisocyanates, including derivatives thereof (e.g., ureas, biurets, allophanates, dimers and trimers of polyisocyanates, and mixtures thereof), (hereinafter collectively referred to as “polyisocyanates”) are the preferred isocyanate-functional materials for the isocyanate-functional component. Polyisocyanates have at least two isocyanate-functional groups and provide urethane linkages when reacted with the preferred hydroxy-functional isocyanate-reactive components.

Generally, diisocyanates are the preferred polyisocyanates. Particularly preferred diisocyanates useful in the present invention can be generally represented by Formula III:
OCN—Z—NCO (III)
wherein Z represents any suitable polyvalent radical, which may be, for example, polymeric or oligomeric. For example, Z can be based on arylene (e.g., phenylene), aralkylene, alkylene, cycloalkylene, polysiloxane (e.g., polydimethyl siloxane), or polyoxyalkylene (e.g., polyoxyethylene, polyoxypropylene, and polyoxytetramethylene) segments and mixtures thereof. Preferably Z has about 1 to about 20 carbon atoms, and more preferably about 6 to about 20 carbon atoms.

For example, Z can be selected from 2,6-tolylene; 2,4-tolylene; 4,4′-methylenediphenylene; 3,3′-dimethoxy-4,4′-biphenylene; tetramethyl-m-xylylene; 4,4′-methylenedicyclohexylene; 3,5,5-trimethyl-3-methylenecyclohexylene; 1,6-hexamethylene; 1,4-cyclohexylene; 2,2,4-trimethylhexylene; or polymeric or oligomeric alkylene, aralkylene, or oxyalkylene radicals and mixtures thereof. When Z is a polymeric or oligomeric material it may include, for example, urethane linkages.

The type of polyisocyanate used for the isocyanate-functional material may affect the properties of the PSA. For example, when symmetrical polyisocyanates are used, an increase in shear strength may be observed, as compared to using the same amount of a nonsymmetrical polyisocyanate. Also, when aromatic polyisocyanates are used, the resulting PSA can yellow upon aging. Typically, when aromatic polyisocyanates are used, they are present in amounts less than 5% in the PSA.

However, any diisocyanate that can react with the isocyanate-reactive material can be used in the present invention. Examples of such diisocyanates include, but are not limited to, aromatic diisocyanates (e.g., 2,6-tolyene diisocyanate; 2,5-tolyene diisocyanate; 2,4-tolyene diisocyanate; m-phenylene diisocyanate; 5-chloro-2,4-tolyene diisocyanate; and 1-chloromethyl-2,4-diisocyanato benzene), aromatic-aliphatic diisocyanates (e.g., m-xylylene diisocyanate and tetramethyl-m-xylylene diisocyanate), aliphatic diisocyanates (e.g., 1,4-diisocyanatobutane; 1,6-diisocyanatohexane; 1,12-diisocyanatododecane; and 2-methyl- 1,5-diisocyanatopentane), and cycloaliphatic diisocyanates (e.g., methylenedicyclohexylene-4,4′-diisocyanate; 3-isocyanatomethyl-3,5,5-trimethylcyclohexyl isocyanate (isophorone diisocyanate); 2,2,4-trimethylhexyl diisocyanate; and cyclohexylene-1,4-diisocyanate), and other compounds terminated by two isocyanate-functional groups (e.g., the diurethane of tolyene-2,4-diisocyanate-terminated polypropylene oxide polyol).

Particularly preferred diisocyanates include: 2,6-tolyene diisocyanate; 2,4-tolyene diisocyanate; tetramethyl-m-xylylene diisocyanate; methylenedicyclohexylene-4,4′-diisocyanate; 3-isocyanatomethyl-3,5,5-trimethylcyclohexyl isocyanate (isophorone diisocyanate); 1,6-diisocyanatohexane; 2,2,4-trimethylhexyl diisocyanate; cyclohexylene-1,4-diisocyanate; methylenedicyclohexylene4,4′-diisocyanate; and mixtures thereof. More particularly preferred are 2,6-tolyene diisocyanate; 2,4-tolyene diisocyanate; tetramethyl-m-xylylene diisocyanate; 3-isocyanatomethyl-3,5,5-trimethylcyclohexyl isocyanate (isophorone diisocyanate); methylenedicyclohexylene-4,4′-diisocyanate; and mixtures thereof.

Although not as preferred as diisocyanates, other polyisocyanates may be used, for example, in combination with diisocyanates, for the polyisocyanate component. For example, triisocyanates may be used. Triisocyanates include, but are not limited to, polyfunctional isocyanates, such as those produced from biurets, isocyanurates, adducts, and the like. Some commercially available polyisocyanates include portions of the DESMODUR and MONDUR series from Bayer Corporation; Pittsburgh, Pa., and the PAPI series from Dow Plastics, a business group of the Dow Chemical Company; Midland, Mich. Preferred triisocyanates include those available from Bayer Corporation under the trade designations DESMODUR N-3300 and MONDUR 489.

Reactive Emulsifying Compound

When preparing polyurethane-based dispersions of the invention, the isocyanate-reactive and isocyanate-functional components are reacted with at least one reactive emulsifying compound. The reactive emulsifying compound contains at least one anionic-functional group, cationic-functional group, group that is capable of forming an anionic-functional group or cationic-functional group, or mixtures thereof. As used herein, the term “reactive emulsifying compound” describes a compound that acts as an internal emulsifier because it contains at least one ionizable group.

Reactive emulsifying compounds are capable of reacting with at least one of the isocyanate-reactive and isocyanate-functional components to become incorporated into the polyurethane prepolymers. Thus, the reactive emulsifying compound contains at least one, preferably at least two, isocyanate- or active hydrogen-reactive (e.g., hydroxy-reactive) groups. Isocyanate- and hydroxy-reactive groups include, for example, isocyanate, hydroxyl, mercapto, and amine groups.

In certain embodiments, the reactive emulsifying compound contains at least one anionic-functional group or group that is capable of forming such a group (i.e., an anion-forming group) when reacted with the isocyanate-reactive (e.g., polyol) and isocyanate-functional (e.g., polyisocyanate) components. The anionic-functional or anion-forming groups of the reactive emulsifying compound can be any suitable groups that contribute to ionization of the reactive emulsifying compound. For example, suitable groups include carboxylate, sulfate, sulfonate, phosphate, and similar groups.

In certain embodiments, the reactive emulsifying compound contains at least one cationic-functional group or group that is capable of forming such a group (i.e., a cation-forming group) when reacted with the isocyanate-reactive (e.g., polyol) and isocyanate-functional (e.g., polyisocyanate) components. The cationic-functional or cation-forming groups of the reactive emulsifying compound can be any suitable groups that contribute to ionization of the reactive emulsifying compound. In most embodiments, the reactive emulsifying compound is an amine.

The incorporation of a reactive emulsifying compound in the polyurethane prepolymer allows for water dispersibility of the polyurethane prepolymer and resulting polymer. Furthermore, such dispersions do not require external emulsifiers, such as surfactants, for stability.

Preferably, a sufficient amount of reactive emulsifying compound is reacted such that an external emulsifier is not necessary for preparing a storage-stable dispersion. When a sufficient amount of the reactive emulsifying compound is used, the polyurethane prepolymers derived therefrom are also able to be dispersed into finer particles using less shear force than what has previously been possible with many conventional dispersions. A sufficient amount is generally such that the resulting polyurethane-based polymer comprises about 0.5 to about 5 weight percent, more preferably about 0.75 to about 3 weight percent, of segments derived from the reactive emulsifying compound. Below this amount, polyurethanes produced therefrom may be difficult to disperse, and dispersions produced therefrom may be unstable (i.e., subject to de-emulsification and/or coagulation at temperatures above room temperature, or at temperatures greater than about 20° C.). However, if polyols containing polyethylene oxide are used, the amount of reactive emulsifying compound used in this preferred embodiment may be less to form a stable dispersion. On the other hand, employing more reactive emulsifying compound in the reaction may produce an unstable dispersion or a resulting PSA that is too sensitive to moisture (i.e., such that physical properties of the PSA are affected to the degree that they are no longer consistently useful for their desired application).

The preferred structure for reactive emulsifying compounds with anionic-functional groups is generally represented by Formula IV: 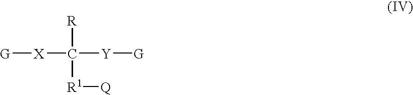
wherein G is OH, NHR or SH and wherein Q is a negatively charged moiety selected from COO⁻and SO₃⁻, or a group that is capable of forming such a negatively charge moiety upon ionization. Each of X, Y, R, and R¹ may be the same or different. X, Y, R, and R¹ are independently selected from aliphatic organic radicals free of reactive functional groups (e.g., alkylene groups that are free of reactive functional groups), preferably having from about 1 to about 20 carbon atoms, and combinations thereof, with the provisos that: (i.) R can be hydrogen; and (ii.) R¹ is not required if Q is COO⁻ and SO₃⁻.

As an example, dimethylolpropionic acid (DMPA) is a useful reactive emulsifying compound for certain embodiments of the invention. Furthermore, 2,2-dimethylolbutyric acid, dihydroxymaleic acid, and sulfopolyester diol are other useful reactive emulsifying compounds.

The preferred structure for reactive emulsifying compounds with cationic-functional groups is generally represented by Formula V: 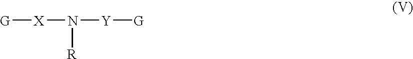
wherein G is OH, NHR or SH. Each of X, Y, and R may be the same or different. X, Y, and R are independently selected from aliphatic organic radicals free of reactive functional groups (e.g., alkylene groups that are free of reactive functional groups), preferably having from about 1 to about 20 carbon atoms, and combinations thereof, with the proviso that R can be hydrogen.

Depending on the desired application, anionic or cationic reactive-emulsifying compounds may be preferable. For example, when an antimicrobial agent is used with the polyurethane-based pressure sensitive adhesives of the present invention, it may be preferred that the reactive emulsifying agent contain a cationic-functional group. In those circumstances, the cationic feature of the PSA would minimize the potential for interaction of the adhesive with the antimicrobial agent. This may be a particular concern, for example, in medical applications.

Other useful compounds for the reactive emulsifying compounds include those described as water-solubilizing compounds in U.S. Pat. No. 5,554,686, which is incorporated herein by reference. Those of ordinary skill in the art will recognize that a wide variety of reactive emulsifying compounds are useful in the present invention.

Chain Capping Agent

When preparing polyurethane-based PSAs of the invention, the isocyanate-functional prepolymer may be reacted with at least one chain capping agent according to certain embodiments of the invention. The chain capping agent is a monofunctional isocyanate-reactive compound that functions to terminate or cap a isocyanate-functional group and produce a chain end. Capping agents can be added prior to chain extension or during the chain extension step.

Any suitable isocyanate-reactive monofunctional compound can be used as a capping agent. When added to the prepolymer prior to chain extension, it may be preferred to add a hydroxyl-functional capping agent. In contrast, when the capping agent is added during the chain extension of the prepolymer, it is preferred that the capping agent be amine-functional. This is due to the fact that chain capping is occurring simultaneously with chain extension (either through the reaction of isocyanate with water to generate an amine which reacts with other isocyanates or with a difunctional amine compound) and it is desirable that the capping reaction be competitive in rate with the chain extension reaction.

Chain capping agents useful in the present invention fall into two general categories: alcohols and amines. Suitable capping agents include, but are not limited to, include dialkyl amines (e.g., dibutylamine, dipropylamine, diisopropylamine, diisobutylamine, dihexylaamine); succinic anhydride; hydroxyl-functional alkyl ethers (e.g., poly ethylene glycol butyl ether and poly ethylene glycol methyl ether); hydroxyl-functional esters such as poly ethylene glycol monolaurate; piperidine; butylamine; ethanolamine; diethanolamine; diisopropanolamine; polyoxyalkylene polyamines (e.g., polyoxyethylene polyamine, polyoxypropylene polyamine, polyoxytetramethylene polyamine), polyalkylene glycols; hexamethyleneimine; aminosilanes and combinations thereof. A class of particularly suitable capping agents are monofunctional amines such as dialkyl amines, and more specifically, dibutyl amine.

The amount of capping agent added to an isocyanate-functional polyurethane prepolymer or the dispersion depends upon the amount of triol present and the desired properties of the formed polymer. At a given diol to triol level for example, the amount of capping agent will have a dramatic effect on cohesive strength. In general, the amount of capping agent used will cap 0 to 50% of the isocyanate groups in the prepolymer. In preferred embodiments, 5 to 40% of the isocyanate groups in the prepolymer are capped. In one embodiment, about 22% of the isocyanate groups were capped with an isocyanate-reactive material ratio of 95:5.

The capping agent combined with the higher-functional hydroxyl groups in the isocyanate-reactive component causes a shift in cohesive strength of the resulting PSA compared to a comparable PSA formed from the same isocyanate-reactive components without the presence of the capping agent. Although dependent in part on the materials chosen, adjustment in the levels of capping agent will generally have more impact on a shift in cohesive strength as measured by shear than adjustment of higher hydroxyl-functional groups in the isocyanate-reactive component.

By controlling the capping agent amounts, along with the diol to triol levels, the adhesive properties can be tailored from high peel with moderate shear to moderate peel with high shear. These properties can be adjusted without the use of tackifiers or plasticizers which can be considered to be contaminates in some applications, such as medical and electronic applications.

While dependent in part in the selection of components, in general, increasing the level of capping agent causes a corresponding decrease in modulus of the resultant PSA. However, as capping levels are increased, shear strength decreases, and thus, triol levels must also be increased to offset the reduction in shear. However, increases in capping levels and triol levels beyond a certain point will result in a descrease in cohesive strength such that the polymer is no longer useful as an adhesive in most applications.

In many applications, the peel strength as measured in the Examples describe below will be greater than 30 N/dm. In most applications, the cohesive strength, as measured by shear, may be greater than 30 minutes. In some applications, such as tape, the cohesive strength may be greater than 500 minutes.

Chain capping agents may be chosen to impart a desired characteristic to the resulting adhesive. The desirable characteristics could include improved adhesion of the adhesive either to a tape backing and/or the intended substrate to be adhered to. Chain capping agents capable of crystallization may be chosen to further improve the cohesive strength of the dried adhesive. The ability of the adhesive to contain additives such as antimicrobial agents may also be enhanced by the selection of the capping agent.

Polyurethane-Based Polymer Preparation

In general, the isocyanate-reactive and isocyanate-functional components, along with the reactive emulsifying compound, are allowed to react, forming an isocyanate-terminated polyurethane prepolymer (i.e., a polymer having a weight average molecular weight of less than about 50,000). Once formed, the polymer generally contains on average less than 2.5 isocyanate-functional groups. In most embodiments, the isocyanate-functional groups on the prepolymer on average range from 2.01 to 2.49. In general, the isocyanate-functional group to isocyanate-reactive group ratio of the reactants is preferably about 1.1 to about 2.5, most typically about 1.5. If the isocyanate-functional group to isocyanate-reactive group ratio is lower than in this preferred range, prepolymer viscosity may be too high to be useful for forming dispersions according to one aspect of the invention.

The isocyanate-terminated polyurethane prepolymer is then chain extended with a chain extending agent (e.g., water (including ambient moisture), a polyamine, a relatively low molecular weight polyol (i.e., a polyol having a weight average molecular weight of less than about 250) and combinations thereof) to increase its molecular weight. When preparing the polymer in a 100% solids system, to chain extend the polyurethane prepolymer, generally the polyurethane prepolymer is first heated to decrease its viscosity.

When preparing the polymer in a waterborne or solventborne system, to chain extend the isocyanate-terminated polyurethane prepolymer, generally the polyurethane prepolymer is first introduced into a dispersing or solvating medium (e.g., water or an organic solvent such as N-methylpyrolidone, acetone, methyl ethyl ketone (MEK), or combinations thereof). The addition of organic solvents in a prepolymer system may also help in reducing the viscosity of the prepolymer, which facilitates formation of the dispersion.

In waterborne systems, typically a neutralizing agent is also added to the polyurethane prepolymer to more easily disperse the polyurethane prepolymer in the dispersing medium, such as those decribed as salt-forming compounds in U.S. Pat. No. 5,554,686, which is incorporated herein by reference. The nature of the reactive emulsifying agent, i.e., whether cationic-functional or anionic-functional, will determine the neutralizing agent used. For example, a base, such as a tertiary amine or alkali metal salt, can be used as a neutralizing agent to neutralize any anion-forming groups in the polymeric chain and more easily disperse the polyurethane prepolymer in the dispersing medium. The neutralizing agent can be added to the polyurethane prepolymer before introducing it into the dispersing medium or alternatively, neutralization can occur after introducing the polyurethane prepolymer into the dispersing medium. In many embodiments, the neutralizing agent is introduced simultaneously with dispersion.

In a waterborne system, the polyurethane prepolymer is chain extended during the dispersion step through the reaction of the isocyanate-functional groups with water, at least one polyamine, or mixtures thereof. Isocyanate-functional groups react with water to form an unstable carbamic acid. The carbamic acid then converts to a primary amine and carbon dioxide. The primary amine forms a urea linkage with any remaining isocyanate-functional groups of the polyurethane prepolymer. When the chain extending agent comprises a polyamine, the polyamine forms urea linkages with the isocyanate-functional groups of the polyurethane prepolymer. Thus, the resulting polyurethane-based polymer contains both urethane and urea linkages therein.

As recognizable to those of ordinary skill in the art, the polyurethane prepolymer may alternatively be chain extended using other suitable chain extenders, which may be selected according to whether the polymer is formed using a 100% solids, solventborne, or waterborne system.

When the chain extending agent comprises a polyamine, any suitable compound having at least two amine functional groups can be used for the polyamine. For example, the compound may be a diamine, triamine, etc. Mixtures of polyamines may also be used for the chain extending agent. In general, the isocyanate-functional group to amine-functional group ratio of the reactants is preferably about 0.1 to about 1.5, most typically about 1.

Examples of polyamines useful in the present invention include, but are not limited to, polyoxyalkylene polyamines, alkylene polyamines, and polysiloxane polyarines. Preferably, the polyamine is a diamine.

The polyoxyalkylene polyamine may be, for example, a polyoxyethylene polyamine, polyoxypropylene polyamine, polyoxytetramethylene polyamine, or mixtures thereof. Polyoxyethylene polyamine may be especially useful when preparing the PSA for medical applications, for example, where a high vapor transfer medium and/or water absorbency may be desirable.

Many polyoxyalkylene polyamines are commercially available. For example, polyoxyalkylene diamines are available under trade designations such as D-230, D-400, D-2000, D-4000, DU-700, ED-2001 and EDR-148 (available from Huntsman Corporation; Houston, Tex., under the family trade designation JEFFAMINE). Polyoxyalkylene triamines are available under trade designations such as T-3000 and T-5000 (available from Huntsman Corporation; Houston, Tex.).

Alkylene polyamines include, for example, ethylene diamine; diethylene triamine; triethylene tetramine; propylene diamine; butylene diamine; hexamethylene diamine; cyclohexylene diamine; piperazine; 2-methyl piperazine; phenylene diamine; tolylene diamine; xylylene diamine; tris(2-aminoethyl) amine; 3,3′-dinitrobenzidine; 4,4′-methylenebis(2-chloroaniline); 3,3′-dichloro-4,4′-biphenyl diamine; 2,6-diaminopyridine; 4,4′-diaminodiphenylmethane; menthane diamine; m-xylene diamine; isophorone diamine; and dipiperidyl propane. Many alkylene polyamines are also commercially available. For example, alkylene diamines are available under trade designations such as DYTEK A and DYTEK EP (available from DuPont Chemical Company; Wilmington, Del.).

The polyurethane-based polymer may then be compounded with other materials to form a PSA having the desired properties. That is, PSAs of the present invention may contain various additives and other property modifiers.

For example, fillers, such as fumed silica, fibers (e.g., glass, metal, inorganic, or organic fibers), carbon black, glass or ceramic beads/bubbles, particles (e.g., metal, inorganic, or organic particles), polyaramids (e.g., those available from DuPont Chemical Company; Wilmington, Del. under the trade designation, KEVLAR), and the like can be added, generally in amounts up to about 50 parts per hundred parts by weight of the polyurethane-based polymer, provided that such additives are not detrimental to the properties desired in the final PSA composition.

Other additives such as dyes, inert fluids (e.g., hydrocarbon oils), plasticizers, tackifiers, pigments, flame retardants, stabilizers, antioxidants, compatibilizers, antimicrobial agents (e.g., zinc oxide), electrical conductors, thermal conductors (e.g., aluminum oxide, boron nitride, aluminum nitride, and nickel particles), and the like can be blended into these compositions, generally in amounts of from about 1 to about 50 percent by total volume of the composition. It should be noted that, although tackifiers and plasticizers may be added, such additives are not necessary for obtaining PSA properties in polyurethane-based adhesives of the invention.

Application

Whether the polyurethane-based PSA is prepared from a solventborne or waterborne system, once the solution or dispersion is formed, it is easily applied to a substrate and then dried to form a PSA coating. Drying can be carried out either at room temperature (i.e., about 20° C.) or at elevated temperatures (e.g., about 25° C. to about 150° C.). Drying can optionally include using forced air or a vacuum. This includes the drying of static-coated substrates in ovens, such as forced air and vacuum ovens, or drying of coated substrates that are continuously conveyed through chambers heated by forced air, high-intensity lamps, and the like. Drying may also be performed at reduced (i.e., less than ambient) pressure.

Where post-crosslinking of the coated polymer is desirable, aminosilanes can be used as the capping agent. Upon coating and drying the polymer dispersion, the aminosilanes will allow crosslinking to occur.

A PSA coating can be formed on a wide variety of substrates. For example, the PSA can be applied to sheeting products (e.g., decorative, reflective, and graphical), labelstock, and tape backings. The substrate can be any suitable type of material depending on the desired application. Typically, the substrate comprises a nonwoven, paper, polymeric film (e.g., polypropylene (e.g., biaxially oriented polypropylene (BOPP)), polyethylene, polyurea, polyurethane, or polyester (e.g., polyethylene terephthalate)), or release liner (e.g., siliconized liner).

PSAs according to the present invention can be utilized to form tape, for example. To form a tape, a PSA coating is formed on at least a portion of a suitable backing. A release material (e.g., low adhesion backsize) can be applied to the opposite side of the backing, if desired. When double-sided tapes are formed, a PSA coating is formed on at least a portion of both sides of the backing.

Antimicrobial Agents

The pressure sensitive adhesives of the present invention can optionally include an antimicrobial (e.g., antibacterial or antifungal) agents. Such actives are capable of destroying microbes, preventing the development of microbes or preventing the pathogenic action of microbes. An effective amount of an antimicrobial agent may be added to the present compositions in an amount to produce a desired effect (e.g., antimicrobial effect). If used, this amount is typically at least 0.001%, based on the total weight of the PSA.

Examples of suitable antimicrobial agents include, but are not limited to, antibiotics such as ciprofloxacin, norfloxacin, tetracyclines, erythromycin, amikacin, and their derivatives; chlorhexidine; antifungals such as miconazole, metronidazole and clotrimazole; chlorhexidine gluconate; chlorhexidine acetate; iodine; pyrithiones (especially zinc pyrithione which is also known as ZPT); and cationic surfactant actives such as benzalkonium chloride, cetyl pyridinium chloride, and cetyl trimethyl ammonium bromide; silver compounds such as silver oxide and silver salts; and combinations thereof.

Another class of antimicrobial agents (i.e., actives), which are useful in the present invention, are the so-called “natural” antibacterial actives, referred to as natural essential oils. These actives derive their names from their natural occurrence in plants. Typical natural essential oil antibacterial actives include oils of anise, lemon, orange, rosemary, wintergreen, thyme, lavender, cloves, hops, tea tree, citronella, wheat, barley, lemongrass, grapefruit seed, cedar leaf, cedarwood, cinnamon, fleagrass, geranium, sandalwood, violet, cranberry, eucalyptus, vervain, peppermint, gum benzoin, basil, fennel, fir, balsam, ocmea origanum, Hydastis carradensis, Berberidaceae daceae, Ratanhiae and Curcuma longa. Also included in this class of natural essential oils are the key chemical components of the plant oils, which have been found to provide the antimicrobial benefit. These chemicals include, but are not limited to, anethol, catechole, camphene, thymol, eugenol, eucalyptol, ferulic acid, farnesol, hinokitiol, tropolone, limonene, menthol, methyl salicylate, carvacol, terpineol, verbenone, berberine, ratanhiae extract, caryophellene oxide, citronellic acid, curcumin, nerolidol and geraniol.

The antimicrobial agent may be added at any point of the polyurethane-based polymer formation process. Generally, the antimicrobial agent will be added at or after the dispersion step.

### EXAMPLES

These examples are merely for illustrative purposes only and are not meant to be limiting on the scope of the appended claims. All parts, percentages, ratios, etc. in the examples and the rest of the specification are by weight, unless noted otherwise. Furthermore, molecular weights in the examples and the rest of the specification are weight average molecular weights, unless noted otherwise. Solvents and reagents used were obtained from Aldrich Chemical Company, Milwaukee, Wis. unless noted otherwise.

The preparation methods and test methods described below were used to characterize polyurethane-based PSA compositions produced in the following examples. Although the examples focus on PSAs prepared from dispersions, as noted earlier, PSAs of the invention may also be prepared from 100% solids and solventborne systems. PSAs prepared from 100% solids and solventborne systems also benefit from the use of chemistries described herein.

Preparation of Pressure-Sensitive Adhesive (PSA) Tapes

The polyurethane-urea dispersion to be tested was cast onto a polyethylene terephthalate (PET) backing at a dry thickness of approximately 25 micrometers using a MEYER rod or a knife coater depending on the viscosity of the dispersion. The coating was allowed to dry at room temperature followed by further drying for 10 minutes in a 70° C. oven. The samples were placed in a constant temperature and humidity room (22° C. and 50% relative humidity) overnight prior to testing.

180° Peel Adhesion

This peel adhesion test is similar to the test method described in ASTM D 3330-90, substituting a glass substrate for the stainless steel substrate described in the test (for the present purpose, also referred to as “glass substrate peel adhesion test”). PSA tapes, prepared as described above, were cut into 1.27-centimeter by 15-centimeter strips. Each strip was then adhered to a 10 centimeter by 20 centimeter clean, solvent-washed glass coupon by passing a 2-kilogram roller once over the strip. The bonded assembly dwelled at room temperature for about one minute.

Each sample so prepared was tested for 180° peel adhesion using an IMASS slip/peel tester (Model 3M90, commercially available from Instrumentors Inc.; Strongsville, Ohio) at a rate of 2.3 meters/minute (90 inches/minute) using a five second data collection time. Two samples of each composition were tested. The reported peel adhesion value is an average of the peel adhesion value from each of the two samples.

Shear Strength

This shear strength test is similar to the test method described in ASTM D 3654-88. PSA tapes, prepared as described above, were cut into 1.27-centimeter by 15-centimeter strips. Each strip was then adhered to a stainless steel panel such that a 1.27-centimeter by 1.27-centimeter portion of each strip was in firm contact with the panel and one end portion of the strip hung free.

The panel with the attached strip was placed in a rack such that the panel formed an angle of 178° with the extended free end of the strip. The strip was tensioned by application of a force of one kilogram applied as a hanging weight from the free end of the strip. The 2° less than 180° was used to negate any peel forces, thus ensuring that only shear strength forces were measured, in an attempt to more accurately determine the holding power of the tape being tested.

The elapsed time for each tape sample to separate from the test panel was recorded as the shear strength. Each test was terminated at 10,000 minutes, unless the adhesive failed at an earlier time (as noted). All shear strength failures (if the adhesive failed at less than 10,000 minutes) reported herein were cohesive failures of the adhesive unless otherwise noted.

Table of Abbreviations

In the following table, the measured weight % of monol for certain of the higher molecular weight polyols was determined using proton-NMR spectroscopy. The weight % monol measured was the proportion of allyl protons with respect to the total number of protons in the polymer backbone of the polyol.

| Abbreviation | |
|---|---|
| or Trade | |
| Designation | Description |
| ACCLAIM | A highly pure polypropylene oxide triol with an |
| 6300 | approximate molecular weight of 6,000 grams/mole |
| | and an OH equivalent weight of approximately |
| | 2,000 grams/mole, and a measured weight % monol |
| | of 0.6, commercially available from Bayer Corp.; |
| | Houston, Texas |
| ACCLAIM | A highly pure polypropylene oxide/polyethylene |
| 3201 | oxide diol with an approximate molecular weight |
| | of 3,000 grams/mole, an OH equivalent weight of |
| | approximately 1,500 grams/mole, and a measured |
| | weight % monol of 0.5, commercially available |
| | from Bayer Corp; Houston, Texas |
| ACCLAIM | A highly pure polypropylene oxide diol with an |
| 4200 | approximate molecular weight of 4,000 grams/mole, |
| | an OH equivalent weight of approximately 2,000 |
| | grams/mole, and a measured weight % monol of 0.6, |
| | commercially available from Bayer Corp; Houston, |
| | Texas |
| ACCLAIM | A highly pure polyethylene oxide-capped |
| 4220N | polypropylene oxide diol with an approximate |
| | molecular weight of 4,000 grams/mole, an OH |
| | equivalent weight of approximately 2,000 |
| | grams/mole, and a measured weight % monol of 2.3, |
| | commercially available from Bayer Corp; Houston, |
| | Texas |
| ACCLAIM | A highly pure polyethylene oxide-capped |
| 6320N | polypropylene oxide triol with an approximate |
| | molecular weight of 6,000 grams/mole and an OH |
| | equivalent weight of approximately 2,000 |
| | grams/mole, and a measured weight % monol of 1.1, |
| | commercially available from Bayer Corp; Houston, |
| | Texas |
| ARCOL | A polypropylene oxide diol with an approximate |
| PPG-425 | molecular weight of 425 grams/mole and an OH |
| | equivalent weight of approximately 212 |
| | grams/mole, commercially available from Bayer |
| | Corp; Houston, Texas |
| ARCOL | A polypropylene oxide diol with an approximate |
| PPG-725 | molecular weight of 725 grams/mole, an OH |
| | equivalent weight of approximately 362 |
| | grams/mole, commercially available from Bayer |
| | Corp; Houston, Texas |
| ARCOL | A polypropylene oxide diol with an approximate |
| PPG-1000 | molecular weight of 1000 grams/mole, an OH |
| | equivalent weight of approximately 500 |
| | grams/mole, commercially available from Bayer |
| | Corp; Houston, Texas |
| BA | Butyl amine |
| CHG | Chlorhexadine gluconate |
| DBA | Dibutyl amine |
| DEOA | Diethanol amine |
| DHA | Dihexyl amine |
| DIBA | Diisobutyl amine |
| DIPA | Diisopropyl amine |
| DIPOA | Diisopropanol amine |
| DMPA | 2,2-dimethylolpropionic acid |
| DPA | Dipropyl amine |
| EDA | Ethylene diamine |
| EOA | Ethanol amine |
| HMI | Hexamethylene imine, commercially available from |
| | E. I. duPont de Nemours & Co.; Wilmington, |
| | Delaware |
| IPDI | Isophorone diisocyanate |
| JEFFAMINE | A poly(oxyethylene/oxypropylene)amine with an |
| M-1000 | approximate molecular weight of 1000 grams/mole, |
| | commercially available from Huntsman |
| | Corporation; Houston, Texas |
| JEFFAMINE | A poly(oxyethylene/oxypropylene)amine with an |
| M-2070 | approximate molecular weight of 2,000 |
| | grams/mole, commercially available from Huntsman |
| | Corporation; Houston, Texas |
| NaOH | 1.0 N sodium hydroxide solution from J. T. |
| | Baker, Phillipsburg, New Jersey |
| N-MDEA | N-methyldiethanolamine |
| PEGBE | Poly(ethylene glycol) butyl ether |
| PEGML | Poly(ethylene glycol) monolaurate |
| PET | An aminated-polybutadiene primed polyester film |
| | of polyethylene terephthalate having a thickness |
| | of 38 micrometers |
| PIP | Piperidine |
| POLYG | A polypropylene oxide/polyethylene oxide triol |
| 85-36 | with an approximate molecular weight of 4,500 |
| | grams/mole, commercially available from Arch |
| | Chemicals, Inc.; Norwalk, Connecticut |
| SA | Succinic anhydride (97% pure) |
| SILQUEST | gamma-aminoproplytriethoxysilane, commercially |
| A-1100 | available from Witco Corp., Tarrytown, New York |
| SILQUEST | N-beta-(aminoethyl)-gamma-aminoproplytrimethyl- |
| A-2120 | dimethoxysilane, commercially available from |
| | Witco Corp., Tarrytown, New York |
| SILQUEST | N-phenyl-gamma-aminoproplytrimethoxysilane, |
| Y-9669 | commercially available from Witco Corp., |
| | Tarrytown, New York |
| T-12 | A dibutyltin dilaurate catalyst, commercially |
| | available from Air Products and Chemicals, |
| | Inc.; Allentown, Pennsylvania |
| TDI | A tolylene 2,4-diisocyanate, tolylene |
| | 2,6-diisocyanate mixture, with a ratio of the |
| | two components of 80:20 grams |
| TEA | Triethylamine |
| TMXDI | tetramethyl-m-xylylene diisocyanate |
| UCON 50- | Polyalkylene glycol having one terminal hydroxyl |
| HB-3520 | group and an approximate molecular weight of |
| | 3,380 grams/mole, commercially available from |
| | Dow Chemical Co., Auburn Hills, Michigan |

### Comparative Example C1

Part I: Prepolymer Preparation

The polyol, ACCLAIM 3201, was dehydrated in-vacuo at 90° C.-100° C. overnight and cooled to room temperature before use. In a glass reaction vessel, 335.00 parts by weight of ACCLAIM 3201, 11.96 parts by weight of DMPA, 170.80 parts by weight of acetone and 51.61 parts by weight TDI were combined. The sealed glass reaction vessel was rotated in a thermostated temperature bath at 80° C. for 43 hours followed by being placed in a 50° C. oven for 1 hour.

Part II: Dispersion Preparation

A premix of 2.70 parts by weight of TEA, 1.65 parts by weight of DBA, and 227 parts by weight of distilled water was prepared. To the water/TEA/DBA premix was dispersed 170.00 parts by weight of the prepolymer prepared in Part I using a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersion prepared in Part II was used to prepare a tape sample as described above. The 180° Peel Adhesion and Shear Strength of the tape sample were tested as described above and are reported in Table 1.

### Example 1

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 307.01 parts by weight of ACCLAIM 3201, 16.16 parts by weight of ACCLAIM 6300, 11.53 parts by weight of DMPA, 164.60 parts by weight of acetone and 49.43 parts by weight of TDI were combined. The sealed glass reaction vessel was rotated in a thermostated temperature bath at 80° C. for 43 hours.

Part II: Dispersion Preparation

A premix of 2.70 parts by weight of TEA, 1.64 parts by weight of DBA, and 227 parts by weight of distilled water was prepared. To the water/TEA/DBA premix was dispersed 170.00 parts by weight of the prepolymer prepared in Part I using a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersion prepared in Part II was used to prepare a tape sample as described above. The 180° Peel Adhesion and Shear Strength of the tape sample were tested as described above and are reported in Table 1.

### Example 2

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 300.00 parts by weight of ACCLAIM 3201, 33.33 parts by weight of ACCLAIM 6300, 11.88 parts by weight of DMPA, 169.60 parts by weight of acetone and 50.60 parts by weight of TDI were combined. The sealed glass reaction vessel was rotated in a thermostated temperature bath at 80° C. for 40 hours followed by being placed in a 50° C. oven for 1 hour.

Part II: Dispersion Preparation

The same procedure described for Example 1, Part II was followed with 2.70 parts by weight of TEA, 1.63 parts by weight of DBA, 227 parts by weight of distilled water, and 170.00 parts by weight of the prepolymer prepared in Part I.

Part III: Tape Preparation

The dispersion prepared in Part II was used to prepare a tape sample as described above. The 180° Peel Adhesion and Shear Strength of the tape sample were tested as described above and are reported in Table 1.

### Example 3

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 270.00 parts by weight of ACCLAIM 3201, 67.50 parts by weight of ACCLAIM 6300, 12.00 parts by weight of DMPA, 171.40 parts by weight of acetone and 50.45 parts by weight of TDI were combined. The sealed glass reaction vessel was rotated in a thermostated temperature bath at 80° C. for 40 hours followed by being placed in a 50° C. oven for 1 hour.

Part II: Dispersion Preparation

The same procedure described for Example 1, Part II was followed with 2.70 parts by weight of TEA, 1.61 parts by weight of DBA, 227 parts by weight of distilled water, and 170.00 parts by weight of the prepolymer prepared in Part I.

Part III: Tape Preparation

The dispersion prepared in Part II was used to prepare a tape sample as described above. The 180° Peel Adhesion and Shear Strength of the tape sample were tested as described above and are reported in Table 1.

TABLE 1

| | | | 180° Peel | |
|---|---|---|---|---|
| | | % of Prepolymer | Adhesion | Shear Strength |
| Example | % Triol | Amine Capped | (N/dm) | (minutes) |
| C1 | 0 | 21.7 | 63.0 | 56 |
| 1 | 5 | 21.7 | 89.7 | 234 |
| 2 | 10 | 21.7 | 86.4 | 675 |
| 3 | 20 | 21.7 | 67.2 | 10,000 |

### Examples 4-9

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 307.01 parts by weight of ACCLAIM 3201, 16.16 parts by weight of ACCLAIM 6300, 11.53 parts by weight of DMPA, 164.60 parts by weight of acetone and 49.43 parts by weight of TDI were combined. The sealed glass reaction vessel was rotated in a thermostated temperature bath at 80° C. for 43 hours.

Part II: Dispersion Preparation

The same procedure described for Example 1, Part II was followed with the reagent amounts listed in Table 2.

TABLE 2

| | Prepolymer (parts | TEA (parts | Water (parts | DBA (parts |
|---|---|---|---|---|
| Example | by weight) | by weight) | by weight) | by weight) |
| 4 | 170.00 | 2.70 | 227 | 0.00 |
| 5 | 170.00 | 2.70 | 227 | 0.75 |
| 6 | 170.00 | 2.70 | 227 | 1.19 |
| 7 | 170.00 | 2.70 | 227 | 1.64 |
| 8 | 170.00 | 2.70 | 227 | 2.08 |
| 9 | 170.00 | 2.70 | 227 | 2.52 |

Part III: Tape Preparation

The dispersions prepared in Part II were used to prepare a tape sample as described above. The 180° Peel Adhesion and Shear Strength of the tape samples were tested as described above and are reported in Table 3.

TABLE 3

| | | | 180° Peel | |
|---|---|---|---|---|
| | | % of Prepolymer | Adhesion | Shear Strength |
| Example | % Triol | Amine Capped | (N/dm) | (minutes) |
| 4 | 5 | 0 | 60.4 | 10,000 |
| 5 | 5 | 9.9 | 68.5 | 10,000 |
| 6 | 5 | 15.7 | 77.2 | 10,000 |
| 7 | 5 | 21.7 | 89.7 | 234 |
| 8 | 5 | 27.5 | 82.9 | 16 |
| 9 | 5 | 33.3 | 0.0 | 3 |

### Examples 10-15

Part I: Prepolymer Preparation

The same procedure and amounts described in Example 1, Part I was followed.

Part II: Dispersion Preparation

The same procedure described for Example 1, Part II was followed using 170.00 parts by weight of the prepolymer, 2.70 parts by weight of TEA and 227 parts by weight of distilled water. The DBA was replaced with different amine end capping agents, these end capping agents and the amounts used are listed in Table 4.

Part III: Tape Preparation

The dispersions prepared in Part II were used to prepare a tape sample as described above. The 180° Peel Adhesion and Shear Strength of the tape samples were tested as described above and are reported in Table 4.

TABLE 4

| | | Amine End | | | |
|---|---|---|---|---|---|
| | | Capping | | | |
| | Amine End | Agent | % of Pre- | | |
| | Capping | Amount | polymer | 180° Peel | Shear |
| Ex- | Agent | (parts by | Amine | Adhesion | Strength |
| ample | Identity | weight) | Capped | (N/dm) | (minutes) |
| 1 | DBA | 1.64 | 21.7 | 89.7 | 234 |
| 10 | DIPA | 1.29 | 21.7 | 74.8 | 10,000 |
| 11 | DIBA | 1.64 | 21.7 | 102.2 | 75 |
| 12 | Jeffamine | 13.45 | 21.7 | 42.2 | 22 |
| | M-1000 | | | | |
| 13 | Jeffamine | 27.54 | 21.7 | 55.4 | 7 |
| | M-2070 | | | | |
| 14 | DIPOA | 1.69 | 21.7 | 235.6 | 35 |
| 15 | DHA | 2.35 | 21.7 | 119.9 | 33 |

### Examples 16-18

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 270.00 parts by weight of ACCLAIM 3201, 67.50 parts by weight of ACCLAIM 6300, 12.00 parts by weight of DMPA, 177.40 parts by weight of acetone and 64.66 parts by weight of IPDI were combined. The sealed glass reaction vessel was rotated in a thermostated temperature bath at 80° C. for 48 hours.

Part II: Dispersion Preparation

The same procedure described for Example 1, Part II was followed using 170.00 parts by weight of the prepolymer, 2.70 parts by weight of TEA and 227-229 parts by weight of distilled water. The amount of DBA used is listed in Table 5.

Part III: Tape Preparation

The dispersions prepared in Part II were used to prepare a tape sample as described above. The 180° Peel Adhesion and Shear Strength of the tape samples were tested as described above and are reported in Table 5.

TABLE 5

| | | | 180° Peel | |
|---|---|---|---|---|
| | DBA (parts | % of Prepolymer | Adhesion | Shear Strength |
| Example | by weight) | Amine Capped | (N/dm) | (minutes) |
| 16 | 1.56 | 21.7 | 76.4 | 10,000 |
| 17 | 2.02 | 28.0 | 96.9 | 2,079 |
| 18 | 2.40 | 33.4 | 166.5 | 199 |

### Example 19

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 288.60 parts by weight of ACCLAIM 3201, 32.07 parts by weight of ACCLAIM 6300, 11.88 parts by weight of DMPA, 169.60 parts by weight of acetone and 63.25 parts by weight of IPDI were combined. The sealed glass reaction vessel was rotated in a thermostated temperature bath at 80° C. for 48 hours.

Part II: Dispersion Preparation

The same procedure described for Example 1, Part II was followed using 170.00 parts by weight of the prepolymer, 2.70 parts by weight of TEA, 2.04 parts by weight of DBA and 228 parts by weight of distilled water.

Part III: Tape Preparation

The dispersions prepared in Part II were used to prepare a tape sample as described above. The 180° Peel Adhesion and Shear Strength of the tape samples were tested as described above and are reported in Table 6.

### Example 20

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 288.60 parts by weight of ACCLAIM 3201, 32.22 parts by weight of ACCLAIM 6300, 11.89 parts by weight of DMPA, 169.90 parts by weight of acetone, 63.41 parts by weight of IPDI and 0.65 parts by weight of T12 catalyst were combined. The sealed glass reaction vessel was rotated in a thermostated temperature bath at 80° C. for 43 hours.

Part II: Dispersion Preparation

The same procedure described for Example 1, Part II was followed using 170.00 parts by weight of the prepolymer, 2.70 parts by weight of TEA, 2.04 parts by weight of DBA and 228 parts by weight of distilled water.

Part III: Tape Preparation

The dispersions prepared in Part II were used to prepare a tape sample as described above. The 180° Peel Adhesion and Shear Strength of the tape samples were tested as described above and are reported in Table 6.

TABLE 6

| | | % of | | 180° Peel | Shear |
|---|---|---|---|---|---|
| | | Prepolymer | Catalyzed | Adhesion | Strength |
| Example | % Triol | Amine Capped | Reaction ? | (N/dm) | (minutes) |
| 19 | 10 | 27.7 | no | 126.0 | 351 |
| 20 | 10 | 27.7 | yes | 145.7 | 470 |

### Example 21

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 270.00 parts by weight of ACCLAIM 3201, 67.50 parts by weight of ACCLAIM 6300, 12.00 parts by weight of DMPA, 177.40 parts by weight of acetone and 64.66 parts by weight of IPDI were combined. The sealed glass reaction vessel was rotated in a thermostated temperature bath at 80° C. for 48 hours.

Part II: Dispersion Preparation

A premix of 2.70 parts by weight of TEA, 1.57 parts by weight of DPA and 227 parts by weight of distilled water was prepared. To the water/amine premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 7.

### Example 22

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 307.01 parts by weight of ACCLAIM 3201, 16.16 parts by weight of ACCLAIM 6300, 12.00 parts by weight o DMPA, 171.20 parts by weight of acetone and 64.32 parts by weight of IPDI were combined. The sealed glass reaction vessel was rotated in a thermostated temperature bath at 80° C. for 41 hours.

Part II: Dispersion Preparation

A premix of 2.70 parts by weight of TEA, 0.66 parts by weight of BA and 225 parts by weight of distilled water was prepared. To the water/amine premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 7.

### Example 23

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 288.60 parts by weight of ACCLAIM 3201, 32.07 parts by weight of ACCLAIM 6300, 11.88 parts by weight of DMPA, 169.60 parts by weight of acetone and 63.25 parts by weight of IPDI were combined. The sealed glass reaction vessel was rotated in a thermostated temperature bath at 80° C. for 48 hours.

Part II: Dispersion Preparation

A premix of 2.70 parts by weight of TEA, 0.76 parts by weight of PIP and 225 parts by weight of distilled water was prepared. To the water/amine premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 7.

### Example 24

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 326.74 parts by weight of ACCLAIM 3201, 36.31 parts by weight of ACCLAIM 6300, 13.45 parts by weight of DMPA, 192.00 parts by weight of acetone and 71.61 parts by weight of IPDI were combined. The sealed glass reaction vessel was rotated in a thermostated temperature bath at 80° C. for 48 hours.

Part II: Dispersion Preparation

A premix of 2.70 parts by weight of TEA, 0.76 parts by weight of EOA and 225 parts by weight of distilled water was prepared. To the water/amine premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 7.

### Example 25

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 288.60 parts by weight of ACCLAIM 3201, 32.07 parts by weight of ACCLAIM 6300, 11.88 parts by weight of DMPA, 169.60 parts by weight of acetone and 63.25 parts by weight of IPDI were combined. The sealed glass reaction vessel was rotated in a thermostated temperature bath at 80° C. for 48 hours.

Part II: Dispersion Preparation

A premix of 2.70 parts by weight of TEA, 0.94 parts by weight of DEOA and 226 parts by weight of distilled water was prepared. To the water/amine premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 7.

### Example 26

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 288.60 parts by weight of ACCLAIM 3201, 32.07 parts by weight of ACCLAIM 6300, 11.92 parts by weight of DMPA, 170.10 parts by weight of acetone and 64.48 parts by weight of IPDI were combined. The sealed glass reaction vessel was rotated in a thermostated temperature bath at 80° C. for 48 hours.

Part II: Dispersion Preparation

A premix of 2.70 parts by weight of TEA, 1.25 parts by weight of HMI and 222 parts by weight of distilled water was prepared. To the water/amine premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 7.

### Example 27

Part I: Prepolymer Preparation

The polyols, ACCLAIM 4200 and ACCLAIM 6300, were dehydrated in-vacuo at 90° C.-100° C. overnight and cooled to room temperature before use. In a glass reaction vessel, 215.32 parts by weight of ACCLAIM 4200, 23.93 parts by weight of ACCLAIM 6300, 8.67 parts by weight of DMPA, 123.70 parts by weight of acetone and 40.78 parts by weight of IPDI were combined. The sealed glass reaction vessel was rotated in a thermostated temperature bath at 80° C. for 48 hours.

Part II: Dispersion Preparation

A premix of 2.70 parts by weight of TEA, 2.61 parts by weight of DBA and 230 parts by weight of distilled water was prepared. To the water/amine premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 7.

### Example 28

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 288.60 parts by weight of ACCLAIM 3201, 32.07 parts by weight of ACCLAIM 6300, 11.92 parts by weight of DMPA, 170.10 parts by weight of acetone and 64.54 parts by weight of IPDI were combined. The sealed glass reaction vessel was rotated in a thermostated temperature bath at 80° C. for 48 hours.

Part II: Dispersion Preparation

A premix of 26.63 parts by weight of 1.0N NaOH, 1.63 parts by weight of DBA and 203 parts by weight of distilled water was prepared. To the water/NaOH/amine premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 7.

TABLE 7

| | | Percent of | 180° Peel | |
|---|---|---|---|---|
| | | Prepolymer | Adhesion | Shear Strength |
| Example | Monoamine | Capped | (N/dm) | (minutes) |
| 21 | DPA | 40.0 | 176.1 | 24 |
| 22 | BA | 15.7 | 121.9 | 106 |
| 23 | PIP | 15.6 | 100.6 | 440 |
| 24 | EOA | 21.7 | 205.7 | 10 |
| 25 | DEOA | 15.6 | 116.2 | 149 |
| 26 | HMI | 21.7 | 122.5 | 94 |
| 27 | DBA | 40.0 | 73.3 | 985 |
| 28 | DBA | 21.7 | 57.3 | 10,000 |

### Example 29

Part I: Prepolymer Preparation

The polyols, ACCLAIM 3201 and ACCLAIM 6300, and the monol, PEGBE, were dehydrated in-vacuo at 90° C.-100° C. overnight and cooled to room temperature before use. In a glass reaction vessel, 193.36 parts by weight of ACCLAIM 3201, 21.49 parts by weight of ACCLAIM 6300, 7.99 parts by weight of DMPA, 114.00 parts by weight of acetone and 43.21 parts by weight of IPDI were combined. The sealed glass reaction vessel was rotated in a thermostated temperature bath at 80° C. for 28 hours. The reaction vessel was cooled to room temperature and 5.34 parts by weight of PEGBE was added to the reaction mixture. The sealed glass reaction vessel was rotated in a thermostated temperature bath at 80° C. for 20 hours.

Part II: Dispersion Preparation

A premix of 2.70 parts by weight of TEA and 226 parts by weight of distilled water was prepared. Then, 170.00 parts by weight of the prepolymer prepared in Part I was dispersed in the water/TEA premix in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 8.

### Example 30

Part I: Prepolymer Preparation

The polyols, ACCLAIM 3201 and ACCLAIM 6300, and the monol PEGME were dehydrated in-vacuo at 90° C.-100° C. overnight and cooled to room temperature before use. In a glass reaction vessel, 193.36 parts by weight of ACCLAIM 3201, 21.49 parts by weight of ACCLAIM 6300, 7.99 parts by weight of DMPA, 114.00 parts by weight of acetone and 43.21 parts by weight of IPDI were combined. The sealed glass reaction vessel was rotated in a thermostated temperature bath at 80° C. for 28 hours. The reaction vessel was cooled to room temperature and 9.07 parts by weight of PEGME was added to the reaction mixture. The sealed glass reaction vessel was rotated in a thermostated temperature bath at 80° C. for 20 hours.

Part II: Dispersion Preparation

The same procedure and amounts described for Example 29, Part II were used.

Part III: Tape Preparation

The dispersions prepared in Part II were used to prepare a tape sample as described above. The 180° Peel Adhesion and Shear Strength of the tape samples were tested as described above and are reported in Table 8.

### Example 31

Part I: Prepolymer Preparation

The polyols, ACCLAIM 3201 and ACCLAIM 6300, and the monol PEGML were dehydrated in-vacuo at 90° C.-100° C. overnight and cooled to room temperature before use. In a glass reaction vessel, 193.36 parts by weight of ACCLAIM 3201, 21.49 parts by weight of ACCLAIM 6300, 7.99 parts by weight of DMPA, 114.00 parts by weight of acetone and 43.21 parts by weight of IPDI were combined. The sealed glass reaction vessel was rotated in a thermostated temperature bath at 80° C. for 28 hours. The reaction vessel was cooled to room temperature and 10.37 parts by weight of PEGML was added to the reaction mixture. The sealed glass reaction vessel was rotated in a thermostated temperature bath at 80° C. for 20 hours.

Part II: Dispersion Preparation

The same procedure and amounts described for Example 29, Part II were used.

Part III: Tape Preparation

The dispersions prepared in Part II were used to prepare a tape sample as described above. The 180° Peel Adhesion and Shear Strength of the tape samples were tested as described above and are reported in Table 8.

### Example 32

Part I: Prepolymer Preparation

The polyols, ACCLAIM 3201 and ACCLAIM 6300, and the monol PEGML were dehydrated in-vacuo at 90° C.-100° C. overnight and cooled to room temperature before use. In a glass reaction vessel, 193.36 parts by weight of ACCLAIM 3201, 21.49 parts by weight of ACCLAIM 6300, 7.99 parts by weight of DMPA, 114.00 parts by weight of acetone and 43.21 parts by weight of IPDI were combined. The sealed glass reaction vessel was rotated in a thermostated temperature bath at 80° C. for 28 hours. The reaction vessel was cooled to room temperature and 13.00 parts by weight of PEGML was added to the reaction mixture. The sealed glass reaction vessel was rotated in a thermostated temperature bath at 80° C. for 20 hours.

Part II: Dispersion Preparation

The same procedure and amounts described for Example 29, Part II were used.

Part III: Tape Preparation

The dispersions prepared in Part II were used to prepare a tape sample as described above. The 180° Peel Adhesion and Shear Strength of the tape samples were tested as described above and are reported in Table 8.

### Example 33

Part I: Prepolymer Preparation

The polyols, ACCLAIM 3201 and ACCLAIM 6300, and the monol UCON 5HB-3520, were dehydrated in-vacuo at 90° C.-100° C. overnight and cooled to room temperature before use. In a glass reaction vessel, 154.69 parts by weight of ACCLAIM 3201, 17.19 parts by weight of ACCLAIM 6300, 6.39 parts by weight of DMPA, 121.30 parts by weight of acetone and 34.57 parts by weight of IPDI were combined. The sealed glass reaction vessel was rotated in a thermostated temperature bath at 80° C. for 28 hours. The reaction vessel was cooled to room temperature and 70.24 parts by weight of UCON 50HB-3520 was added to the reaction mixture. The sealed glass reaction vessel was rotated in a thermostated temperature bath at 80° C. for 20 hours.

Part II: Dispersion Preparation

A premix of 2.70 parts by weight of TEA, 1.37 parts by weight of EDA and 224 parts by weight of distilled water was prepared. To the water/TEA/EDA premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 8.

TABLE 8

| | | Percent of | 180° Peel | |
|---|---|---|---|---|
| | | Prepolymer | Adhesion | Shear Strength |
| Example | Monol | Capped | (N/dm) | (minutes) |
| 29 | PEGBE | 9.1 | 89.5 | 44 |
| 30 | PEGME | 9.1 | 104.8 | 34 |
| 31 | PEGML | 9.1 | 75.7 | 10,000 |
| 32 | PEGML | 11.1 | 65.6 | 1,509 |
| 33 | UCON 5HB-3520 | 9.1 | 96.5 | 54 |

### Examples 34-36 and Comparative Example C2

Parts I & II: Prepolymer and Dispersion Preparation

In a reaction flask equipped with a stirrer, temperature controller and a nitrogen/vacuum inlet was placed 125.02 parts by weight of Acclaim 3201, 22.05 parts by weight of Acclaim 6300, and 5.54 parts by weight of DMPA. The mixture was stirred and heated to 105° C. and dehydrated at 25 mm Hg vacuum for 1 hour and then cooled to room temperature. To this stirred mixture was added of 32.11 parts by weight of TMXDI and 0.06 parts by weight of T12 catalyst. The contents were heated to 95° C. and stirred for 5 hours to form the prepolymer. Aliquots of 25 parts by weight were withdrawn from the flask, neutralized with 0.56 parts by weight of TEA, and dispersed into 67.6 parts by weight of distilled water with an Omnimixer Homogenizer Model # 17105 (commercially available from Omni International, Inc.; Warrenton, Va.). To these dispersions was added dropwise EDA or EDA and DBA according to the amounts shown it Table 9, followed by further dispersing and magnetic stirring for 16 hours in a 60° C. water bath.

Part III: Tape Preparation

The dispersions prepared in Parts I & II were used to prepare a tape sample as described above. The 180° Peel Adhesion and Shear Strength of the tape samples were tested as described above and are reported in Table 9.

TABLE 9

| | | | % of | | |
|---|---|---|---|---|---|
| | | | Prepolymer | 180° Peel | |
| | | | Amine | Adhesion | Shear Strength |
| Example | % Triol | % EDA | Capped | (N/dm) | (minutes) |
| C2 | 15 | 80 | 0 | 79.4 | 1,709 |
| 34 | 15 | 80 | 3 | 83.8 | 782 |
| 35 | 15 | 80 | 6 | 76.3 | 497 |
| 36 | 15 | 80 | 9 | 86.2 | 211 |

### Examples 37-38 and Comparative Examples C3-C4

Part I: Preparation of Diol

In a reaction flask equipped with a stirrer, temperature controller and a nitrogen/vacuum inlet was placed 619.46 parts by weight of POLYG 85-36. The flask was heated at 105° C. for one hour under vacuum then filled with nitrogen. To the flask was added 13.67 parts by weight of SA and the resulting mixture was heated at 150° C. for 4 hours. After 4 hours, the infrared spectra showed no remaining absorption at the carbonyl peaks associated with the anhydride, (1788 and 1866 cm⁻¹).

Part II: Preparation of the Prepolymers and Dispersions

In a reaction flask equipped with a stirrer, temperature controller and a nitrogen/vacuum inlet was placed 125.00 parts by weight of the polyol prepared in Part I, 22.07 parts by weight of Acclaim 6300, and 22.07 of the mixture prepared by combining 56.87 parts by weight of PPG 725 with 56.93 parts by weight of PPG 425 and 56.99 parts by weight of PPG 1000. The mixture is stirred and heated to 105° C. and dehydrated for one hour at 25 mm Hg vacuum. After cooling to room temperature, 33.78 parts by weight of TMXDI and 0.06 parts by weight of T12 catalyst was added and the mixture was stirred and heated to 95° C. for 5 hours. Aliquots of 25 parts by weight were removed from the flask, neutralized with 0.33 parts by weight of TEA, and dispersed into 65 parts by weight of distilled water with an Omnimixer Homogenizer Model # 17105 (commercially available from Omni International, Inc.; Warrenton, Va.). To these dispersions was added dropwise EDA or EDA and DBA according to the amounts shown it Table 10, followed by further dispersing and magnetic stirring for 16 hours in a 60° C. water bath.

Part III: Tape Preparation

The dispersions prepared in Parts I & II were used to prepare a tape sample as described above. The 180° Peel Adhesion and Shear Strength of the tape samples were tested as described above and are reported in Table 10.

TABLE 10

| | | | % of | 180° Peel | Shear |
|---|---|---|---|---|---|
| | | | Prepolymer | Adhesion | Strength |
| Example | % Triol | % EDA | Amine Capped | (N/dm) | (minutes) |
| C3 | 13 | 50 | 0 | 41.5 | 8 |
| 37 | 13 | 50 | 5 | 47.5 | 5.5 |
| C4 | 13 | 81 | 0 | 22.1 | 10,000 |
| 38 | 13 | 81 | 5 | 46.8 | 207* |

*Failure mode was adhesive, no residue was left on the panel

### Example 39

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 288.60 parts by weight of ACCLAIM 3201, 32.07 parts by weight of ACCLAIM 6300, 11.92 parts by weight of DMPA, 170.10 parts by weight of acetone and 64.48 parts by weight of IPDI were combined. The sealed glass reaction vessel was rotated in a thermostated temperature bath at 80° C. for 48 hours.

Part II: Dispersion Preparation

A premix of 2.70 parts by weight of TEA, 4.27 parts by weight of SILQUEST A-1100 and 233 parts by weight of distilled water was prepared. To the water/amine premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 11.

### Example 40

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 288.60 parts by weight of ACCLAIM 3201, 32.07 parts by weight of ACCLAIM 6300, 11.92 parts by weight of DMPA, 170.10 parts by weight of acetone and 64.48 parts by weight of IPDI were combined. The sealed glass reaction vessel was rotated in a thermostated temperature bath at 80° C. for 48 hours.

Part II: Dispersion Preparation

A premix of 2.70 parts by weight of TEA, 4.92 parts by weight of SILQUEST Y-9669 and 235 parts by weight of distilled water was prepared. To the water/amine premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 11.

### Example 41

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 288.60 parts by weight of ACCLAIM 3201, 32.07 parts by weight of ACCLAIM 6300, 11.92 parts by weight of DMPA, 170.10 parts by weight of acetone and 64.48 parts by weight of IPDI were combined. The sealed glass reaction vessel was rotated in a thermostated temperature bath at 80° C. for 48 hours.

Part II: Dispersion Preparation

A premix of 2.70 parts by weight of TEA, 1.99 parts by weight of SILQUEST A-2120 and 233 parts by weight of distilled water was prepared. To the water/amine premix was dispersed 170.00 parts by weight of the prepolymer prepared in Part I in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar.

Part III: Tape Preparation

The dispersions prepared in Part II were used to prepare a tape sample as described above. The 180° Peel Adhesion and Shear Strength of the tape samples were tested as described above and are reported in Table 11.

TABLE 11

| | | Percent of | 180° Peel | Shear |
|---|---|---|---|---|
| | | Prepolymer | Adhesion | Strength |
| Example | Monoamine | Capped | (N/dm) | (minutes) |
| 39 | SILQUEST A-1100 | 33.3 | 56.0 | 10,000 |
| 40 | SILQUEST Y-9669 | 33.3 | 62.8 | 10,000 |
| 41 | SILQUEST A-2120 | 33.3 | 42.9 | 10,000 |

### Example 42

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 163.33 parts by weight of ACCLAIM 3201, 70.00 parts by weight of ACCLAIM 6300, 9.15 parts by weight of DMPA, 130.8 parts by weight of acetone, 62.33 parts by weight of IPDI and 0.47 parts by weight of dibutyltin dilaurate catalyst were combined. The sealed glass reaction vessel was rotated in a thermostated temperature bath at 80° C. for 17 hours.

Part II: Dispersion Preparation

A premix of 2.70 parts by weight of TEA, 4.70 parts by weight of DBA and 234 parts by weight of distilled water was prepared. Then, 170.00 parts by weight of the prepolymer prepared in Part I was dispersed in the water/amine premix in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar. The 180° peel adhesion and shear strength of the tape sample were tested as described above and are reported in Table 12.

### Example 43

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 135.00 parts by weight of ACCLAIM 3201, 90.00 parts by weight of ACCLAIM 6300, 8.82 parts by weight of DMPA, 125.7 parts by weight of acetone, 59.25 parts by weight of IPDI and 0.45 parts by weight of dibutyltin dilaurate catalyst were combined. The sealed glass reaction vessel was rotated in a thermostated temperature bath at 80° C. for 17 hours.

Part II: Dispersion Preparation

A premix of 2.70 parts by weight of TEA, 4.70 parts by weight of DBA and 234 parts by weight of distilled water was prepared. Then, 170.00 parts by weight of the prepolymer prepared in Part I was dispersed in the water/amine premix in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar. The 180° peel adhesion and shear strength of the tape sample were tested as described above and are reported in Table 12.

### Example 44

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 135.00 parts by weight of ACCLAIM 3201, 90.00 parts by weight of ACCLAIM 6300, 8.82 parts-by weight of DMPA, 125.8 parts by weight of acetone and 59.25 parts by weight of IPDI were combined. The sealed glass reaction vessel was rotated in a thermostated temperature bath at 80° C. for 66 hours.

Part II: Dispersion Preparation

A premix of 2.70 parts by weight of TEA, 9.38 parts by weight of DBA and 245 parts by weight of distilled water was prepared. Then, 170.00 parts by weight of the prepolymer prepared in Part I was dispersed in the water/amine premix in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar. The 180° peel adhesion and shear strength of the tape sample were tested as described above and are reported in Table 12.

### Example 45

Part I: Prepolymer Preparation

The polyols, ACCLAIM 3201 and ACCLAIM 6300, were dehydrated in-vacuo at 90° C.-100° C. overnight and cooled to room temperature before use. In a glass reaction vessel, 112.00 parts by weight of ACCLAIM 3201, 112.00 parts by weight of ACCLAIM 6300, 8.74 parts by weight of DMPA, 124.7 parts by weight of acetone and 58.35 parts by weight of IPDI were combined. The sealed glass reaction vessel was rotated in a thermostated temperature bath at 80° C. for 66 hours.

Part II: Dispersion Preparation

A premix of 2.70 parts by weight of TEA, 9.24 parts by weight of DBA and 245 parts by weight of distilled water was prepared. Then, 170.00 parts by weight of the prepolymer prepared in Part I was dispersed in the water/amine premix in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar. The 180° peel adhesion and shear strength of the tape sample were tested as described above and are reported in Table 12.

TABLE 12

| | Diol:Triol Ratio | NCO/DBA | Peel | Shear |
|---|---|---|---|---|
| Example | (weight) | (equivalents) | (N/dm) | (minutes) |
| 42 | 70:30 | 3.0 | 53.6 | 10,000 |
| 43 | 60:40 | 3.0 | 43.5 | 10,000 |
| 44 | 60:40 | 1.5 | 119.0 | 248 |
| 45 | 50:50 | 1.5 | 84.5 | 214 |

### Comparative Example C5

Part I: Prepolymer Preparation

The polyol, ACCLAIM 4220N was dehydrated in-vacuo at 90° C.-100° C. for about six hours and cooled to room temperature before use. In a glass reaction vessel, 210.36 parts by weight of ACCLAIM 4220N, 7.60 parts by weight of N-MDEA, 110.3 parts by weight of acetone, 39.29 parts by weight of IPDI and 0.20 parts by weight of dibutyltin dilaurate catalyst were combined. The sealed glass reaction vessel was rotated in a thermostated temperature bath at 80° C. for 16 hours.

Part II: Dispersion Preparation

A premix of 1.67 parts by weight of acetic acid and 406 parts by weight of distilled water was prepared. Then, 160.00 parts by weight of the prepolymer prepared in Part I was dispersed in the water/acetic acid premix in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar. The 180° peel adhesion and shear strength of the tape sample were tested as described above and are reported in Table 13.

### Example 46

Part I: Prepolymer Preparation

The polyols, ACCLAIM 4220N and ACCLAIM 6320N, were dehydrated in-vacuo at 90° C.-100° C. for about six hours and cooled to room temperature before use. In a glass reaction vessel, 199.88 parts by weight of ACCLAIM 4220N, 10.52 parts by weight of ACCLAIM 6320N, 7.60 parts by weight of N-MDEA, 110.3 parts by weight of acetone, 39.27 parts by weight of IPDI and 0.20 parts by weight of dibutyltin dilaurate catalyst were combined. The sealed glass reaction vessel was rotated in a thermostated temperature bath at 80° C. for 16 hours.

Part II: Dispersion Preparation

A premix of 1.67 parts by weight of acetic acid and 406 parts by weight of distilled water was prepared. Then, 160.00 parts by weight of the prepolymer prepared in Part I was dispersed in the water/acetic acid premix in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar. The 180° peel adhesion and shear strength of the tape sample were tested as described above and are reported in Table 13.

### Example 47

Part I: Prepolymer Preparation

The polyols, ACCLAIM 4220N and ACCLAIM 6320N, were dehydrated in-vacuo at 90° C.-100° C. for about six hours and cooled to room temperature before use. In a glass reaction vessel, 190.17 parts by weight of ACCLAIM 4220N, 21.13 parts by weight of ACCLAIM 6320N, 7.60 parts by weight of N-MDEA, 110.8 parts by weight of acetone, 39.29 parts by weight of IPDI and 0.20 parts by weight of dibutyltin dilaurate catalyst were combined. The sealed glass reaction vessel was rotated in a thermostated temperature bath at 80° C. for 16 hours.

Part II: Dispersion Preparation

Same as Example 46, Part II. The 180° peel adhesion and shear strength of the tape sample were tested as described above and are reported in Table 13.

### Example 48

Part I: Prepolymer Preparation

The polyols, ACCLAIM 4220N and ACCLAIM 6320N, were dehydrated in-vacuo at 90° C.-100° C. for about six hours and cooled to room temperature before use. In a glass reaction vessel, 180.00 parts by weight of ACCLAIM 4220N, 31.77 parts by weight of ACCLAIM 6320N, 7.64 parts by weight of N-MDEA, 111.0 parts by weight of acetone, 39.40 parts by weight of IPDI and 0.20 parts by weight of dibutyltin dilaurate catalyst were combined. The sealed glass reaction vessel was rotated in a thermostated temperature bath at 80° C. for 16 hours.

Part II: Dispersion Preparation

Same as Example 46, Part II. The 180° peel adhesion and shear strength of the tape sample were tested as described above and are reported in Table 13.

### Example 49

Part I: Prepolymer Preparation

The polyols, ACCLAIM 4220N and ACCLAIM 6320N, were dehydrated in-vacuo at 90° C.-100° C. for about six hours and cooled to room temperature before use. In a glass reaction vessel, 168.00 parts by weight of ACCLAIM 4220N, 42.00 parts by weight of ACCLAIM 6320N, 7.72 parts by weight of N-MDEA, 137.3 parts by weight of acetone, 39.43 parts by weight of IPDI and 0.41 parts by weight of dibutyltin dilaurate catalyst were combined. The sealed glass reaction vessel was rotated in a thermostated temperature bath at 80° C. for 16 hours.

Part II: Dispersion Preparation

A premix of 1.68 parts by weight of acetic acid and 391 parts by weight of distilled water was prepared. Then, 170.00 parts by weight of the prepolymer prepared in Part I was dispersed in the water/acetic acid premix in a Microfluidics Homogenizer Model # HC-5000 (commercially available from Microfluidics Corp.; Newton, Mass.) at a line air pressure of 0.621 MPa. The dispersion was stirred vigorously overnight at room temperature with a magnetic stirring bar. The 180° peel adhesion and shear strength of the tape sample were tested as described above and are reported in Table 13.

### Comparative Example C6

Part I: Prepolymer Preparation

The polyols, ACCLAIM 4220N and ACCLAIM 6320N, were dehydrated in-vacuo at 90° C.-100° C. for about six hours and cooled to room temperature before use. In a glass reaction vessel, 84.60 parts by weight of ACCLAIM 4220N, 28.20 parts by weight of ACCLAIM 6320N, 4.03 parts by weight of N-MDEA, 73.5 parts by weight of acetone, 20.83 parts by weight of IPDI and 0.12 parts by weight of dibutyltin dilaurate catalyst were combined. The sealed glass reaction vessel was rotated in a thermostated temperature bath at 80° C. for 16 hours.

Part II: Dispersion Preparation

Not made—prepolymer was too viscous to disperse.

TABLE 13

| | Diol:Triol Ratio | Peel | Shear |
|---|---|---|---|
| Example | (weight) | (N/dm) | (minutes) |
| C5 | 100:0 | 100.2 | 12 |
| 46 | 95:5 | 73.7 | 44 |
| 47 | 90:10 | 76.6 | 93 |
| 48 | 85:15 | 84.2 | 201 |
| 49 | 80:20 | 73.7 | 5,151 |
| C6 | 75:25 | NT | NT |

*NT = Not tested

### Example 50

Part I: Prepolymer Preparation

Same as Example 46, Part I.

Part II: Dispersion Preparation

Same as Example 46, Part II except that 41 parts by weight of a 19% solids CHG solution in water was added to the dispersion. The 180° peel adhesion and shear strength of the tape sample were tested as described above and are reported in Table 14.

### Example 51

Part I: Prepolymer Preparation

Same as Example 47, Part I.

Part II: Dispersion Preparation

Same as Example 47, Part II except that 37.7 parts by weight of a 19% solids CHG solution in water was added to the dispersion. The 180° peel adhesion and shear strength of the tape sample were tested as described above and are reported in Table 14.

### Example 52

Part I: Prepolymer Preparation

Same as Example 48, Part I.

Part II: Dispersion Preparation

Same as Example 48, Part II except that 41 parts by weight of a 19% solids CHG solution in water was added to the dispersion. The 180° peel adhesion and shear strength of the tape sample were tested as described above and are reported in Table 14.

### Example 53

Part I: Prepolymer Preparation

Same as Example 49, Part I.

Part II: Dispersion Preparation

Same as Example 49, Part II except that 44.75 parts by weight of a 19% solids CHG solution in water was added to the dispersion. The 180° peel adhesion and shear strength of the tape sample were tested as described above and are reported in Table 14.

TABLE 14

| | Diol:Triol Ratio | Peel | Shear |
|---|---|---|---|
| Example | (weight) | (N/dm) | (minutes) |
| 50 | 95:5 | 106 | 20 |
| 51 | 90:10 | 91.5 | 94 |
| 52 | 85:15 | 71.3 | 3794 |
| 53 | 80:20 | 81.4 | 10,000 |

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments set forth herein and that such embodiments are presented by way of example only, with the scope of the invention intended to be limited only by the claims.

1. A polyurethane-based pressure sensitive adhesive, comprising the reaction product of:
an isocyanate-reactive component comprising at least two isocyanate-reactive materials, the at least two isocyanate-reactive materials comprising:
a first isocyanate-reactive material comprising at least one diol having a weight average molecular weight of at least about 2,000, wherein the at least one diol comprises less than about 8 weight % monols, and
a second isocyanate-reactive material comprising at least one polyol with more than two hydroxy-functional groups;
an isocyanate-functional component;
a reactive emulsifying compound;
a chain capping agent; and
an optional chain extending agent;
wherein the adhesive is prepared from a waterborne system.

2. The polyurethane-based pressure sensitive adhesive of claim 1, wherein the second isocyanate-reactive material comprises a triol.

3. The polyurethane-based pressure sensitive adhesive of claim 1, wherein the isocyanate-reactive component comprises at least one polyoxyalkylene polyol.

4. The polyurethane-based pressure sensitive adhesive of claim 1, wherein at least one of the first and second isocyanate-reactive materials is a polyol having a ratio of polyol molecular weight to weight % monol of at least about 800.

5. The polyurethane-based pressure sensitive adhesive of claim 1, wherein both of the first and second isocyanate-reactive materials is a polyol having a ratio of polyol molecular weight to weight % monol of at least about 800.

6. The polyurethane-based pressure sensitive adhesive of claim 1, wherein the reactive emulsifying compound is represented by the formula IV: 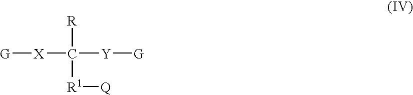
wherein G is selected from the group consisting of OH, NHR or SH;
wherein Q is a negatively charged moiety selected from the group consisting of COO⁻ and SO₃⁻, or a group that is capable of forming such a negatively charged moiety upon ionization;
wherein each of X, Y, and R¹ may be the same or different;
wherein each of X, Y, and R¹ are independently selected from aliphatic organic radicals having from about 1 to about 20 carbon atoms, free of reactive functional groups, and combinations thereof;
wherein R can be hydrogen or an aliphatic organic radical having from about 1 to about 20 carbon atoms, free of reactive functional groups, and combinations thereof;
and wherein R¹ is optional.

7. The polyurethane-based pressure sensitive adhesive of claim 1, wherein the reactive emulsifying compound is represented by the formula V: 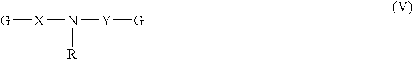
wherein G is selected from the group consisting of OH, NHR or SH;
wherein each of X and Y, may be the same or different;
wherein each of X and Y are independently selected from aliphatic organic radicals having from about 1 to about 20 carbon atoms, free of reactive functional groups, and combinations thereof; and
wherein R can be hydrogen or an aliphatic organic radical having from about 1 to about 20 carbon atoms, free of reactive functional groups, and combinations thereof.

8. The polyurethane-based pressure sensitive adhesive of claim 1, wherein the second isocyanate-reactive material comprises up to 50 percent by weight of the isocyanate-reactive material component.

9. The polyurethane-based pressure sensitive adhesive of claim 1, wherein the ratio of the first isocyanate-reactive material to the second isocyanate-reactive material ranges from 95:5 to 70:30.

10. The polyurethane-based pressure sensitive adhesive of claim 1, wherein the pressure sensitive adhesive contains less than 5% by weight of aromatic content.

11. The polyurethane-based pressure sensitive adhesive of claim 1, wherein the pressure sensitive adhesive exhibits a peel strength on glass greater than 30 Newtons per decimeter.

12. The polyurethane-based pressure sensitive adhesive of claim 1, wherein the pressure sensitive adhesive exhibits a shear strength greater than 30 minutes.

13. The polyurethane-based pressure sensitive adhesive of claim 1, wherein the pressure sensitive adhesive exhibits a shear strength greater than 500 minutes.

14. The polyurethane-based pressure sensitive adhesive of claim 1, wherein the isocyanate-functional component comprises a diisocyanate.

15. The polyurethane-based pressure sensitive adhesive of claim 1, wherein the reactive emulsifying compound comprises at least about 0.5% by weight of the total reactants.

16. A substrate at least partially coated with the polyurethane-based pressure sensitive adhesive of claim 1.

17. The polyurethane-based pressure sensitive adhesive of claim 1, further comprising an antimicrobial agent.

18. The polyurethane-based pressure sensitive adhesive of claim 17, wherein the antimicrobial agent is chlorhexadine gluconate.

19. The polyurethane-based pressure sensitive adhesive of claim 18, wherein the reactive emulsifying compound contains a cationic-functional group.

20. A tape comprising:
a backing having a first and second side; and
the pressure sensitive adhesive of claim 1 coated on at least a portion of the first side of the backing and, optionally, on at least a portion of the second side of the backing.

21. A method of preparing a polyurethane-based pressure sensitive adhesive comprising:
providing an isocyanate-reactive component comprising at least two isocyanate-reactive materials, the at least two isocyanate-reactive materials comprising:
a first isocyanate-reactive material comprising at least one diol having a weight average molecular weight of at least about 2,000, wherein the at least one diol comprises less than about 8 weight % monols, and
a second isocyanate-reactive material comprising at least one polyol with more than two hydroxyl-functional groups;
providing an isocyanate-functional component;
providing a reactive emulsifying compound;
allowing the isocyanate-reactive component, the isocyanate-functional component, and the reactive emulsifying compound to react to form an isocyanate-functional polyurethane prepolymer;
adding a chain capping agent; and
chain extending the polyurethane prepolymer.

22. The method of claim 21, further comprising dispersing the polyurethane prepolymer in a dispersing medium.

23. The method of claim 22, further comprising coating and drying the dispersing medium to form a coating of the polyurethane-based pressure sensitive adhesive.

24. The method of claim 21, wherein the chain extending is provided using a chain extending agent selected from the group consisting of water and polyamines, and combinations thereof.

25. The method of claim 21, further comprising adding an antimicrobial agent.

26. The method of claim 21, wherein the chain capping agent is added in an amount effective to cap up to 50% of the isocyanate-functional groups of the prepolymer.

27. The method of claim 21, wherein the chain capping agent is added in an amount effective to cap between 5 and 40% of the isocyanate-functional groups of the prepolymer.

28. The method of claim 21, wherein the isocyanate-functional prepolymer contains on average less than 2.5 isocyanate-functional groups.

29. A method of preparing a polyurethane-based pressure sensitive adhesive comprising:
providing an isocyanate-reactive component comprising at least two isocyanate-reactive materials, the at least two isocyanate-reactive materials comprising:
a first isocyanate-reactive material comprising at least one diol having a weight average molecular weight of at least about 2,000, wherein the at least one diol comprises less than about 8 weight % monols, and
a second isocyanate-reactive material comprising at least one polyol with more than two hydroxyl-functional groups;
providing an isocyanate-functional component;
providing a reactive emulsifying compound;
providing a chain capping agent;
allowing the isocyanate-reactive component, the isocyanate-functional component, the reactive emulsifying compound, and the chain capping agent to react to form an isocyanate-functional polyurethane prepolymer; and
chain extending the polyurethane prepolymer.

30. A polyurethane-based pressure sensitive adhesive, comprising the reaction product of:
an isocyanate-reactive component comprising at least two isocyanate-reactive materials, the at least two isocyanate-reactive materials comprising:
a first isocyanate-reactive material comprising at least one difunctional compound with two active hydrogens having a weight average molecular weight of at least about 2,000, wherein the at least one difunctional compound comprises less than about 8 weight % monofunctional compounds, and
a second isocyanate-reactive material comprising at least one multifunctional compound with at least three active hydrogens;
an isocyanate-functional component;
a reactive emulsifying compound;
a chain capping agent; and
an optional chain extending agent;
wherein the adhesive is prepared from a waterborne system.
